(19) United States
(12) Patent Application Publication
(10) Pub. No.: US 2026/0358888 A1
(43) Pub. Date: Nov. 12, 2026

(54) SYSTEMS AND METHODS FOR GENERATING PERSONALIZED INTERACTIONS

(71) Applicant: TOYOTA MOTOR NORTH AMERICA, INC., Plano, TX (US)

(72) Inventors: Rob HECKEL, Katy, TX (US); Mark A. MCCLUNG, Celina, TX (US); Steven S. BASRA, Frisco, TX (US); Charan S. LOTA, Frisco, TX (US); Benjamin R. RESNICK, Plano, TX (US); Ryan WHEELER, Denton, TX (US); Lokesh Kumar VISWAVARAPU, Frisco, TX (US); Raja Shekar KILARU, Addison, TX (US); Nikhil RAJENDRA, Plano, TX (US)

(73) Assignees: TOYOTA MOTOR NORTH AMERICA, INC., Plano, TX (US); TOYOTA JIDOSHA KABUSHIKI KAISHA, Aichi-ken (JP)

(21) Appl. No.: 19/204,042

(22) Filed: May 9, 2025

(51) Int. Cl. G06F 3/01

(52) U.S. Cl. CPC G06F 3/015; G06F 3/012; G06F 2203/011

(57) ABSTRACT

Embodiments described herein include systems and methods for personalizing interactions and communications with a user through interactions generated by a generative artificial intelligence. An apparatus may be configured to cause one or more user interface devices to implement a first interaction with a user; obtain, from one or more sensors, user centric information corresponding to the user and the first interaction; categorize the user centric information into one or more categories corresponding to one or more human responses conveyed in the user centric information; generate a second interaction with a generative artificial intelligence (AI) based on a prompt comprising instructions to minimize negative human responses in the user centric information by changing one or more characteristics of the first interaction, and the user centric information categorized into the one or more categories; and cause the one or more user interface devices to implement the second interaction with the user.

### TECHNICAL FIELD

The present specification generally relates to techniques for personalizing interactions and communications with a user.

### BACKGROUND

User interfaces and related techniques for interacting and communicating with drivers continue to evolve. As vehicle technology advances, for example, through the implementation of new sensor systems and new feedback that is available to a driver there is a need to improve user interfaces and related techniques for interacting and communicating with drivers. This needs stems from the anxiety and stress that vehicle technology advances impart on drivers. That is, the lack of familiarity or understanding of advanced vehicle systems can low adoption of the advanced vehicle systems by drivers. Accordingly, systems and methods that improve user interfaces and related techniques for interacting and communicating with drivers regarding the advanced vehicle systems can improve driver adoption, understanding, and utilization of the beneficial advanced vehicle systems.

### SUMMARY

In embodiments, an apparatus includes one or more memories; and one or more processors coupled to the one or more memories and configured to cause the apparatus to: cause one or more user interface devices to implement a first interaction with a user; obtain, from one or more sensors, user centric information corresponding to the user and the first interaction; categorize the user centric information into one or more categories corresponding to one or more human responses conveyed in the user centric information; generate a second interaction with a generative artificial intelligence (AI) based on a prompt comprising instructions to minimize negative human responses in the user centric information by changing one or more characteristics of the first interaction, and the user centric information categorized into the one or more categories; and cause the one or more user interface devices to implement the second interaction with the user.

In some embodiments, a method includes causing one or more user interface devices to implement a first interaction with a user; obtaining, from one or more sensors, user centric information corresponding to the user and the first interaction; categorizing the user centric information into one or more categories corresponding to one or more human responses conveyed in the user centric information; generating a second interaction with a generative artificial intelligence (AI) based on a prompt comprising instructions to minimize negative human responses in the user centric information by changing one or more characteristics of the first interaction, and the user centric information categorized into the one or more categories; and causing the one or more user interface devices to implement the second interaction with the user.

Other embodiments provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 depicts an illustrative system for personalizing interactions and communications with a user.

FIG. 2 depicts an illustrative vehicle implemented with the system depicted in FIG. 1.

FIG. 3 depicts another illustrative environment for capturing user centric information of a user.

FIG. 4 depicts an illustrative block diagram for personalizing interactions and communications with a user.

FIG. 5 depicts an illustrative flow diagram personalizing interactions and communications with a user.

FIG. 6 further depicts an illustrative apparatus for personalizing interactions and communications with a user.

### DETAILED DESCRIPTION

Advanced vehicle systems, such as autonomous operation and semi-autonomous operation of vehicles continue to evolve and are implemented in varying degrees to assist a driver with operational control of a vehicle. Through this evolution, techniques for interacting and communicating with drivers also needs to evolve. Interaction and communication advances are needed to improve driver understanding of the advanced vehicle systems, improve the comfort and driving experience, and ease a driver's stress and anxiety in response to the evolution of vehicle systems.

Embodiments of the present disclosure provide techniques for personalizing interactions and communications with drivers. Through personalizing interactions and communications with drivers, tensions can be eased, understanding of advanced vehicle systems can be improved, and the overall driver experience can be advanced. In certain embodiments, interactions and communications may manifest through user interfaces such as a display and/or audio within a vehicle. In some embodiments, interactions and communications may manifest as a virtual companion, such as a type of artificial intelligence (AI) application that provides a virtual entity for a driver to interact. The techniques described herein are directed to customizing these and other manifestations for interactions and communications with a driver in response to active and/or passive feedback from a driver.

For example, in some embodiments, vehicle cabins may include one or more driver centric, and optionally passenger centric, sensor systems. The sensor systems may sense features of the driver such as facial expression, spoken words, heartbeat, heart rate, perspiration, breathing rate, eye movement, and the like. The information collected maybe correlated with a generative artificial intelligence (AI) model and/or one or more other machine learning models to develop an understanding of the driver's response to an aspect of the environment. In embodiments described herein, the embodiments of the environment generally relate to vehicle systems and interaction processes implemented by an interface platform of the vehicle with the driver. The generative AI model and/or one or more other machine learning models adaptively learn to minimize negative responses of the driver. For example, the generative AI model may generate variations to a user interface, language and/or tone used in communicating with the driver, brightness or color of user interfaces, the frequency and/or type of information provided to a driver, among other interaction and communication implementations. The variations generated by the generative AI model enable a reinforcement learning process whereby the feedback is based on the monitoring of a passenger's reaction (e.g. stress level, tone of passenger voice, facial expression, words used, actions taken, and the like) to the changes of the user interfaces and related techniques implemented for interacting and communicating with the driver.

In certain embodiments, a generative AI system may be used to reinforce learning by monitoring the passenger's reaction to the changes of the user interfaces. The generative AI may have a generative virtual companion to make recommendations where the virtual companion may be personalized with feedback training.

The system may include a database of user feedback and reaction data, including facial expressions, voice recordings, and any other relevant information that can indicate user reactions. The system may also include a second database of user interface variations. This dataset may indicate different designs, layouts, and elements that can be modified.

The system may include one or more sensors and a user expression monitoring module to monitor the user's reaction and expression. The system can intentionally change the user interface and monitor the reaction of the user to determine whether the user has a positive or negative reaction to the changes. Feedback regarding the reaction of the user can be used to continuously improve the system's ability to generate user interfaces that enhance a driver's experience and/or learning process for advance vehicle systems.

The system may also learn individualized user interface appearance preferences that may reduce the stress level of the passengers.

The system may further include a virtual companion that may be personalized according to the profile of the vehicle owner. The virtual companion's appearance and interaction patterns with the user may also be continuously trained by intentionally changed and monitoring the user's reactions. As such, the virtual companion may provide personalized recommendations to the user, such as indicating that an oil change is due, be aware of mileage due to lease terms, or the like.

Embodiments of the present disclosure are directed to techniques for personalizing interactions and communications with drivers. The following will now describe these systems and methods in more detail with reference to the drawings and where like numbers refer to like structures.

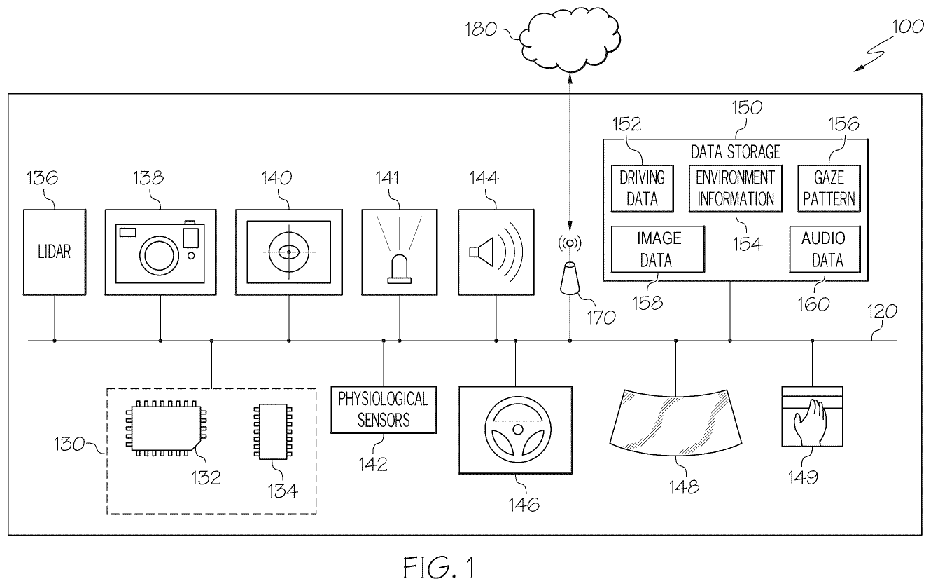

Referring now to FIG. 1, a system 100 for personalizing interactions and communications with drivers is depicted. The system 100 may include an electronic control unit 130. The electronic control unit 130 may include one or more processors 132 and one or more memory components 134. The system 100 may also include a communication bus 120, a LIDAR system 136, one or more cameras 138, a gaze-tracking system 140, an illuminating device 141, one or more physiological sensors 142, a speaker 144, a steering wheel system 146, a heads-up display system 148, a vehicle display 149, a data storage component 150 and/or network interface hardware 170. As referred to herein, the term “one or more environment sensors” may include the LIDAR system 136, one or more cameras 138, and/or a variety of other sensor systems capable of ascertaining information about the environment around a vehicle and functionality of the vehicle such as a vehicle speed, a rate of acceleration or deceleration of the vehicle, a vehicle location, a vehicle heading, or the like. The system 100 may be communicatively coupled to a network 180 by way of the network interface hardware 170. The components of the system 100 are communicatively coupled to each other via the communication bus 120.

It is understood that the embodiments depicted and described herein are not limited to the components or configurations depicted and described with respect to FIG. 1, rather FIG. 1 is merely for illustration. The various components of the system 100 and the interaction thereof will be described in detail below.

The communication bus 120 may be formed from any medium that is capable of transmitting a signal such as, for example, conductive wires, conductive traces, optical waveguides, or the like. The communication bus 120 may also refer to the expanse in which electromagnetic radiation and their corresponding electromagnetic waves traverses. Moreover, the communication bus 120 may be formed from a combination of mediums capable of transmitting signals. In one embodiment, the communication bus 120 comprises a combination of conductive traces, conductive wires, connectors, and buses that cooperate to permit the transmission of electrical data signals to components such as processors 132, memories, sensors, input devices, output devices, and communication devices. Accordingly, the communication bus 120 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication bus 120 communicatively couples the various components of the system 100. As used herein, the term “communicatively coupled” means that coupled components are capable of exchanging signals with one another such as, for example, electrical signals via conductive medium, electromagnetic signals via air, optical signals via optical waveguides, and the like.

The electronic control unit 130 may be any device or combination of components comprising one or more processors 132 and one or more memory components 134. The one or more processors 132 of the system 100 may be any device capable of executing the machine-readable instruction set stored in the one or more memory components 134. Accordingly, the one or more processors 132 may be an electric controller, an integrated circuit, a microchip, a field programmable gate array, a computer, or any other computing device. The processor 132 is communicatively coupled to the other components of the system 100 by the communication bus 120. Accordingly, the communication bus 120 may communicatively couple any number of processors 132 with one another, and allow the components coupled to the communication bus 120 to operate in a distributed computing environment. Specifically, each of the components may operate as a node that may send and/or receive data. While the embodiment depicted in FIG. 1 includes a single processor 132, other embodiments may include more than one processor 132.

The one or more memory components 134 of the system 100 are coupled to the communication bus 120 and communicatively coupled to the one or more processors 132. The memory component 134 may be a non-transitory computer readable memory and may comprise RAM, ROM, flash memories, hard drives, or any non-transitory memory device capable of storing machine-readable instructions such that the machine-readable instructions can be accessed and executed by the processor 132. The machine-readable instruction set may comprise logic or algorithm(s) written in any programming language of any generation (e.g., 1GL, 2GL, 3GL, 4GL, or 5GL) such as machine language that may be directly executed by the processor 132, or assembly language, object-oriented programming (OOP), scripting languages, microcode, etc., that may be compiled or assembled into machine readable instructions and stored in the memory component 134. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the system 100 depicted in FIG. 1 includes a single memory component 134, other embodiments may include more than one memory component 134.

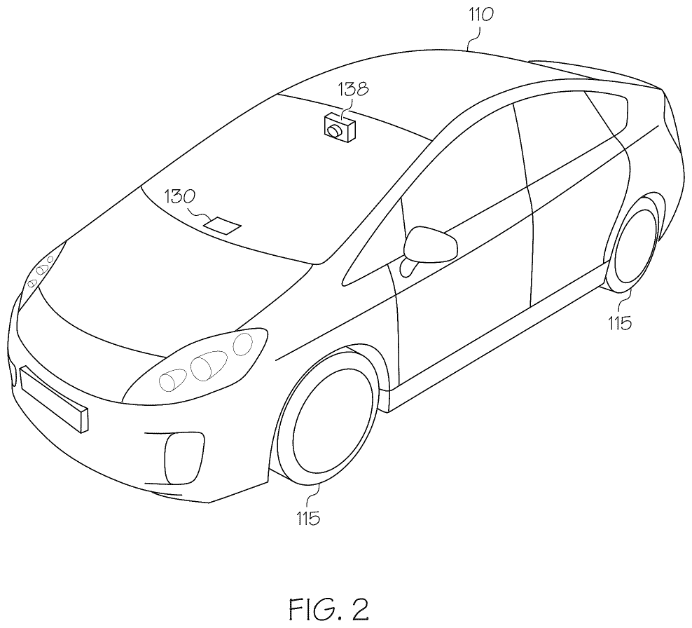

Still referring to FIG. 1, in some embodiments, the system 100 may include a LIDAR system 136. The LIDAR system 136 is communicatively coupled to the communication bus 120 and the electronic control unit 130. The LIDAR system 136 is used in a light detection and ranging system that uses pulsed laser light to measure distances from the LIDAR system 136 to objects that reflect the pulsed laser light. The LIDAR system 136 may be made of solid-state devices with few or no moving parts, including those configured as optical phased array devices where its prism-like operation permits a wide field-of-view without the weight and size complexities associated with a traditional rotating LIDAR sensor. The LIDAR system 136 is particularly suited to measuring time-of-flight, which in turn can be correlated to distance measurements with objects that are within a field-of-view of the LIDAR system 136. By calculating the difference in return time of the various wavelengths of the pulsed laser light emitted by the LIDAR system 136, a digital 3-D representation of a target or environment may be generated. The pulsed laser light emitted by the LIDAR system 136 may be operated in or near the infrared range of the electromagnetic spectrum, with one example having emitted radiation of about 905 nanometers. Sensors such as LIDAR system 136 can be used by vehicles such as vehicle 110 (FIG. 2) to provide detailed 3-D spatial information for the identification of objects near the vehicle 110, as well as the use of such information in the service of systems for vehicular mapping, navigation and autonomous operations, especially when used in conjunction with geo-referencing devices such as GPS or a gyroscope-based inertial navigation unit (INU, not shown) or related dead-reckoning system, as well as non-transitory computer readable memory 134 (either its own or memory of the electronic control unit 130).

The system 100 may also include one or more cameras 138. The one or more cameras 138 may be communicatively coupled to the communication bus 120 and to the processor 132. The one or more cameras 140 may be any device having an array of sensing devices (e.g., pixels) capable of detecting radiation in an ultraviolet wavelength band, a visible light wavelength band, or an infrared wavelength band. The one or more cameras 138 may have any resolution. The one or more cameras 138 may be an omni-directional camera, or a panoramic camera, for example. In some embodiments, one or more optical components, such as a mirror, fish-eye lens, or any other type of lens may be optically coupled to each of the one or more cameras 138. In embodiments described herein, the one or more cameras 138 may capture image data or video data of an environment of a vehicle. That is, with reference to FIG. 2, a vehicle 110 having wheels 115 may include one or more cameras 138 mounted thereon. The one or more cameras 138 may be mounted on a dashboard of a vehicle 110, on a rearview mirror, or elsewhere on the vehicle 110 such that the one or more cameras 138 may capture road-scene data of the environment around a vehicle 110. In some embodiments, the vehicle 110 may further include one or more components of the system 100 such as an electronic control unit 130 configured to implement or interface with a generative AI model and/or one or more machine learning models as described herein. That is, the sensor systems may sense features of the driver such as facial expression, spoken words, heartbeat, heart rate, perspiration, breathing rate, eye movement, and the like. The information collected maybe correlated with the generative AI model and/or one or more other machine learning models to develop an understanding of the driver's response to an aspect of the environment. The generative AI model and/or one or more other machine learning models adaptively learn to minimize negative responses of the driver.

In certain embodiments, the system 100 may include a gaze-tracking system 140 for tracking an eye or gaze direction of a subject to generate a gaze direction vector for determining where a driver is looking. The gaze-tracking system 140 may include one or more cameras 138 and/or an array of infrared light detectors positioned to view one or more eyes of a subject. The gaze-tracking system 140 may also include or be communicatively coupled to an illuminating device 141 which may be an infrared or near-infrared light emitter. The illuminating device 141 may emit infrared or near-infrared light, which may be reflected off a portion of the eye creating a profile that is more readily detectable than visible light reflections off an eye for eye-tracking purposes.

The gaze-tracking system 140 may also obtain facial feature information which may be utilized to determine a user's emotional response to stimuli and categorize it as a positive or negative response. This facial expression information may be obtain from image data captured by the gaze-tracking system 140 and fed through a machine learning model, such as FaceSync. FaceSync is an illustrative example of a framework for capturing and distilling image data, for example, from a camera or gaze-tracking system into a facial expression representations. The facial expression representations may then be processed by one or more various types of neural networks, convolutional neural networks, and/or decoder transformer based models. For example, a multi-modal visual-acoustic processing generative transformer based decoder may be configured to receive facial feature information, audio information, and other sensor data to decode and output facial expression information corresponding to and/or classified as an emotional response.

The gaze-tracking system 140 may be spatially oriented in an environment and generate a gaze direction vector. One of a variety of coordinate systems may be implemented such as user coordinate system (UCS). For example, the UCS has its origin at the center of the front surface of the gaze-tracker. With the origin defined at the center of the front surface (e.g., the eye-tracking camera lens) of the gaze-tracking system 140, the gaze direction vector may be defined with respect to the location of the origin. Furthermore, when spatially orienting the gaze-tracking system 140 in the environment, all other objects including the one or more cameras 138 may be localized with respect to the location of the origin of the gaze-tracking system 140. In some embodiments, an origin of the coordinate system may be defined at a location on the subject, for example, at a spot between the eyes of the subject. Irrespective of the location of the origin for the coordinate system, a calibration process may be employed by the gaze-tracking system 140 to calibrate a coordinate system for collecting gaze-tracking data.

Still referring to FIG. 1, the system 100 may further include one or more physiological sensors 142. The one or more physiological sensors 142 may be communicatively coupled to the communication bus 120 and to the one or more processors 132. The one or more physiological sensors 142 may be any device capable of monitoring and capturing physiological states of the human body, such as a driver's stress level through monitoring electrical activity of the heart, skin conductance, respiration, or the like. The one or more physiological sensors 142 include sensors configured to measure bodily events such as heart rate change, electrodermal activity (EDA) , muscle tension, and cardiac output. The one or more physiological sensors 142 may monitor brain waves through electroencephalography, EEG, electrodermal activity through a skin conductance response, SCR, and galvanic skin response, GSR, cardiovascular measures such as heart rate, HR; beats per minute, BPM; heart rate variability, HRV; vasomotor activity, muscle activity through electromyography, EMG, changes in pupil diameter with thought and emotion through pupillometry (e.g., pupillometry data), eye movements, recorded via the electro-oculogram, EOG and direction-of-gaze methods, and cardiodynamics recorded via impedance cardiography, or other physiological measures.

The physiological sensors 142 may generate physiological response data to determine a response of a driver. For example, a speed of change, the degree of change, or the intensity of the resulting physiological condition such as the speed or amount of pupil dilation or elevation in heart rate may be captured by the one or more physiological sensors 142. The observed changes may be translated into a state of awareness of conditions within the environment.

The system 100 may also include a speaker 144. The speaker 144 (i.e., an audio output device) is coupled to the communication bus 120 and communicatively coupled to the processor 132. The speaker 144 transforms audio message data as signals from the processor 132 of the electronic control unit 130 into mechanical vibrations producing sound. For example, the speaker 144 may provide audio communication, for example, from a virtual companion to the driver. However, it should be understood that, in other embodiments, the system 100 may not include the speaker 144.

The steering wheel system 146 is coupled to the communication bus 120 and communicatively coupled to the electronic control unit 130. The steering wheel system 146 may comprise a plurality of sensors located in the steering wheel for determining a driver grip on the steering wheel, the degree of rotation applied to the steering wheel or the forces applied in turning or maintaining the steering wheel. The steering wheel system 146 may provide signals to the electronic control unit 130 indicative of the location and number of hands on the steering wheel, the strength of the grip on the steering wheel, or changes in position of one or more hands on the steering wheel. The steering wheel system 146, for example, without limitation, may include pressure sensors, inductive sensors, optical sensors, or the like. In addition to detecting the location, number, grip and change in position of one or more hands on the steering wheel, the steering wheel system 146 may also include one or more sensors indicating the rotational angle of the steering wheel and corresponding signals to the electronic control unit 130. The combination of steering wheel rotation, steering wheel grip, and/or position of hands on the steering wheel may be suggestive of a driver's response to stimuli within the vehicle.

The heads-up display system 148 may be included with the system 100 for presenting visual indications to a driver. For example, a heads-up display system 148 may highlight or annotated portions of the environment as a means of communicating and interacting with the driver. A heads-up display system 148 may be a display device integrated with the windshield or other display device within the vehicle. In some embodiments, the heads-up display system 148 may include a projector that projects images onto the windshield through one or more lens systems. However, this is only one example implementation of a heads-up display system 148.

The system 100, for example, as implemented in a vehicle 110 (FIG. 2), may include a vehicle display 149. The vehicle display 149 may be a display device. The display device may include any medium capable of transmitting an optical output such as, for example, a cathode ray tube, light emitting diodes, a liquid crystal display, a plasma display, or the like. The vehicle display 149 may be configured to display a visual alert or warning message, image data, a map of the vehicle environment, or the like to the driver. The visualization on the vehicle display 149 may assist in bringing one or more portions of an environment to the driver's attention. The vehicle display 149 may also include one or more input devices. The one or more input devices may be any device capable of transforming user contact into a data signal that can be transmitted over the communication bus 120 such as, for example, a button, a switch, a knob, a microphone or the like. In some embodiments, the one or more input devices include a power button, a volume button, an activation button, a scroll button, or the like. The one or more input devices may be provided so that the user may interact with the vehicle display 149, such as to navigate menus, make selections, set preferences, and other functionality described herein. In some embodiments, the input device includes a pressure sensor, a touch-sensitive region, a pressure strip, or the like.

A data storage component 150 that is communicatively coupled to the system 100 may be a volatile and/or nonvolatile digital storage component and, as such, may include random access memory (including SRAM, DRAM, and/or other types of random access memory), flash memory, registers, compact discs (CD), digital versatile discs (DVD), and/or other types of storage components. The data storage component 150 may reside local to and/or remote from the system 100 and may be configured to store one or more pieces of data (e.g., driving data 152, environment information 154, gaze patterns 156, image data 158, and/or audio data 160) for access by the system 100 and/or other components. As illustrated in FIG. 1, the data storage component 150 stores, for example, driving data 152 that may include information from one or more environment sensors recorded during past driving events. The driving data 152 may include image data, LIDAR data, speed data, location information, navigation or route information, acceleration or deceleration activity, or the like. The driving data 152 may also include user profile information, such as the audio level, station the driver tunes into, the climate settings for a user, and the like.

The data storage component 150 may also include environment information 154. The environment information 154 includes information generated by one or more environment sensors. In some embodiments, the information from the one or more environment sensors may be temporarily stored in the data storage component 150 before processing by the electronic control unit 130. While in some embodiments, the environment information 154 is recorded for later analysis by the generative AI and/or one or more machine learning models. The data storage component 150 may also record and/or store gaze pattern data 156 generated by the gaze-tracking system 140. The data storage component 150 may also store image data 158 and/or audio data 160 obtained by the one or more sensors in the vehicle cabin. This information may be utilized by the generative AI and/or one or more machine learning models to determine a driver's response to stimuli, such as interaction and/or communications between the vehicle systems and the driver.

Still referring to FIG. 1, the system 100 may also include network interface hardware 170 that is communicatively coupled to the electronic control unit 130 via the communication bus 120. The network interface hardware 170 may include any wired or wireless networking hardware, such as a modem, LAN port, Wi-Fi card, WiMax card, mobile communications hardware, and/or other hardware for communicating with a network 180 and/or other devices and systems. For example, the system 100 may be communicatively coupled to a network 180 by way of the network interface hardware 170.

Turning now to FIG. 2, an illustrative vehicle 110 implemented with the system 100 is depicted. The system 100 may be implemented in a vehicle 110 having one or more wheels 115. The vehicle 110 may include one or more environment sensors, for example, one or more cameras 138 mounted on the vehicle 110 and communicatively coupled to an electronic control unit 130. The vehicle 110 may be a level 1, level 2, level 3, level 4, or level 5 autonomous vehicle 110. While an automobile is utilized as the vehicle 110 for purposes of describing the techniques for personalizing interactions and communications with drivers, it should be understood that the techniques described herein may not be implemented in a vehicle 110. For example, the techniques may be implemented within a workspace, a living space, and/or another type of vehicle.

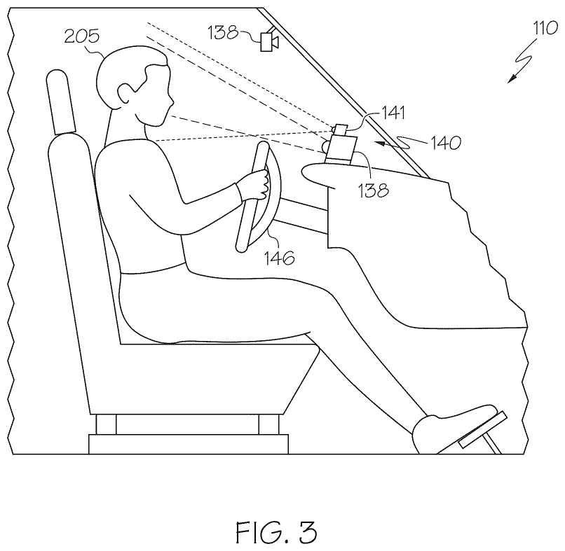

The vehicle 110 may also include a gaze-tracking system 140 for monitoring the state of a driver 205, as illustratively depicted in FIG. 3. The gaze-tracking system 140 may be positioned in the vehicle 110 so that a camera or detection device (e.g., 138) is configured to capture eye, head, and/or body positions of the driver. The gaze-tracking system 140 may also obtain facial feature information which may be utilized to determine a user's emotional response to stimuli and categorize it as a positive or negative response. An illuminating device 141, for example, an infrared lamp, may direct infrared light toward the driver to enhance detection of eye, head, and/or body positions, which may translate into gaze direction vectors.

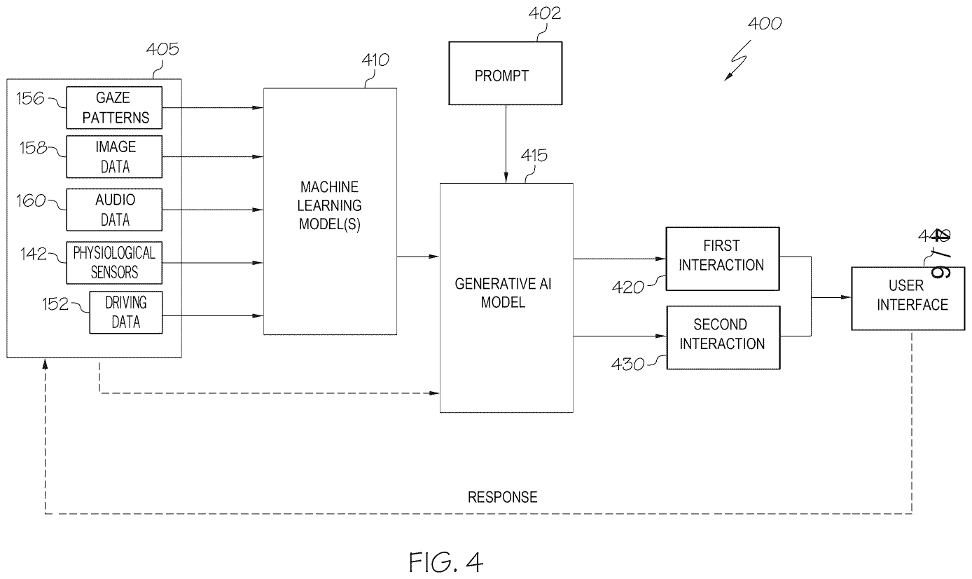

Referring now to FIG. 4, an illustrative block diagram 400 for personalizing interactions and communications with a user is depicted. In certain embodiments, the techniques utilize generative AI models and/or one or more machine learning models in an iterative manner to generate unique interactions with a user, monitor the feedback from the user and then make additional adjustments to the interactions until one or more human responses from the user are generally positive (e.g., minimizing negative responses) to the interaction. As a result, user interfaces and the techniques implemented through the user interfaces can be improved and personalized for a user. Accordingly, not only can the experience of a user, for example, interacting with systems of a vehicle be improved, but information regarding those systems can be conveyed in a manner that is more positively received by the user and thus making those systems more effective in their operation.

In certain embodiments, components of the system 100 including, but not limited to the electronic control unit 130, a user interface device (e.g., comprising a speaker 144, a heads-up display system 148, a vehicle display 149, and the like) may be configured to implement one or more processes described with reference to the illustrative block diagram 400 for personalizing interactions and communications with a user that is depicted in FIG. 4. In certain embodiments, user centric information is collected by the one or more sensors. The one or more sensors may include the one or more cameras 138, the gaze-tracking system 140, the one or more physiological sensors 142, the steering wheel system 146, a microphone, and the like. The user centric information may be collected at predefined intervals, for example, following a change in the interaction through the user interface device or on a continual basis. The user centric information may be raw data or preprocessed data. For example, the user centric information may include gaze patterns 156, image data 158, audio data 160, physiological data from the one or more physiological sensors 142, user profile information from the driving data 152, and/or other data sensed and collected by the one or more sensors.

The user centric information 405 is correlated to interactions with the user interface device 440. For example, the interactions may include instances where the user interface conveys information to the user. These instances may include indicating that an oil change is due, awareness of mileage due to lease terms, route guidance information, information regarding an advance driving system such as an alert to a road hazard or change in a condition around the environment of the vehicle, a suggestion for a station to listen to, a climate control setting, and/or other communicative interaction with the user, for example, a driver of a vehicle.

Each interaction may be defined not only by the content that is conveyed, but also by one or more characteristics that define how the content was conveyed. It is these characteristics that can give rise to different human response from the user. It is also these characteristics that can be adjusted while conveying the same content and invoke a different human response from the user. In particular, techniques of the present disclosure are intended to improve how information is conveyed such that positive human responses are invoked in the user.

By way of example, a user interface device 440 is caused to convey information using a first interaction to a user, where the first interaction is defined by a first set of characteristics. The one or more sensors are configured to obtain user centric information from the user in response to the conveyance of the information using the first interaction through the user interface.

The user centric information 405 may be processed in one or more different means to obtain a categorization of the user centric information. In one embodiment, one or more machine learning models 410 trained to semantically parse respective types of data into one or more categories may be utilized. In some embodiments, a generative AI model receive the user centric information directly and proceed with categorizing and generating a second interaction based on at least the user centric information. Other embodiments may implement one or more other means of handling the user centric information.

In embodiments that utilize the one or more machine learning models 410, machine learning models 410 such as a linear classifier, a support vector machine, and/or logistic regression may be used for audio classification. The audio data may be analyzed and classified by tone, volume, language used, word usage, and/or the like. The classification corresponds to one or more categories that define one or more human responses conveyed in the user centric information 405. For example, if the tone of an audio utterance corresponds to frustration or stress the audio utterance would be categorized as such. In such embodiments, other user centric information may also be considered by respective machine learning models. For example, one or more machine learning models 410 trained to extract and analyze facial features and expressions may be implemented to determine the response of a user. For example, redness of the face may indicated frustration, sweating may indicate stress, and increase in eye movement may indicate anxiety, or clenching of the jaw or other facial muscles may indicate irritation or other emotions. The one or more machine learning models 410 may be trained to perceive one or more human behaviors that indicate a human response to the interaction through the user interface device 440.

In embodiments, a generative AI model 415 is utilized to generate interactions for conveying information to a user through the user interface device 440. In some embodiments, the generative AI model may receive the user centric information and the categorization of the user centric information from the one or more machine learning models 410. In other embodiments, for example, where no additional machine learning models 410 are utilized the generative AI model 415 may receive the user centric information 405 directly for processing. The generative AI model 415 is initiated to carry out the task of generating interactions for conveying information to a user through the user interface device 440 by a prompt 402. A prompt 402 is a customized set of instructions that corresponds to the respective generative AI model 415 and gives the generative AI model 415 guidance and locations of information such as the user centric information 405 to perform one or more desired tasks. For example, a prompt 402 provide an instruction set such as, generate a communication to a user for conveying information from an advanced vehicle system to a user that minimizes a negative human response to the user based on the user centric information corresponding to a previous conveyance of information comprising the characteristics defined by the first interaction 420.

In response to the aforementioned illustrative prompt 402, the generative AI model 415 may generate a second interaction 430 based on the prompt 402 that minimizes a negative human response by changing one or more characteristics of the first interaction and further based on the and the user centric information categorized into the one or more categories that was obtained in response to the first interaction. The first interaction 420 and the second interaction 430 may include define one or more characteristics for conveying the information to the user. The one or more characteristics may include a tone of voice, a layout or design of content presented, an audio or visual intensity, an amount of information conveyed in the first interaction, or other characteristic.

In some embodiments, the first interaction 420 and the second interaction 430 may be implemented by a virtual companion model through the one or more user interface devices 440.

The generative AI model may be a model such as, ChatGPT or DALL-E created by OpenAI, Google Bard from Google, or other generative AI model. In some embodiments, the model, such as the generative AI model, is configured to continuously obtain audio data from a cabin of the vehicle and visual data from the cabin of the environment, and optionally other sensor data concurrently and in real-time.

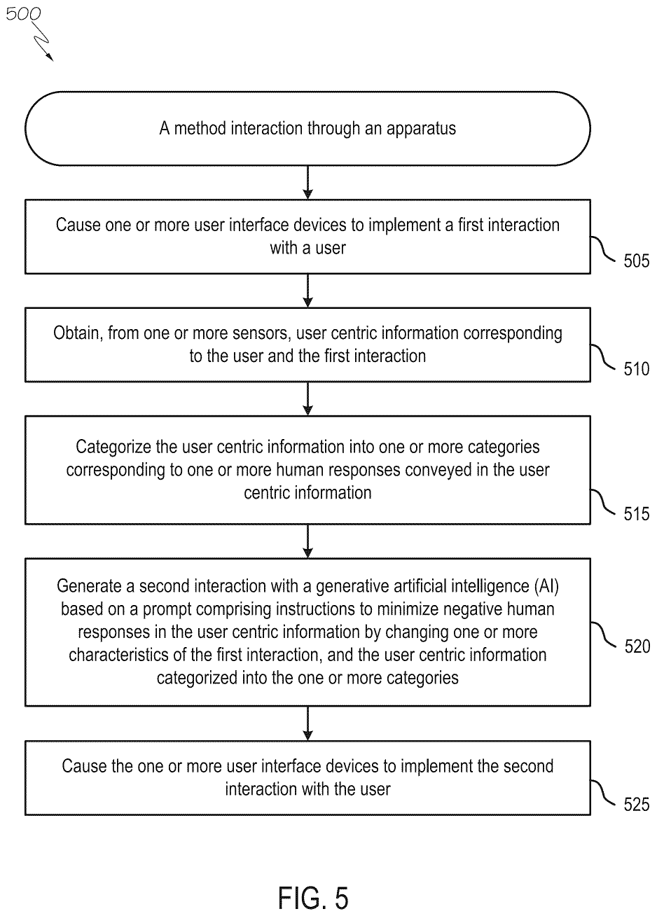

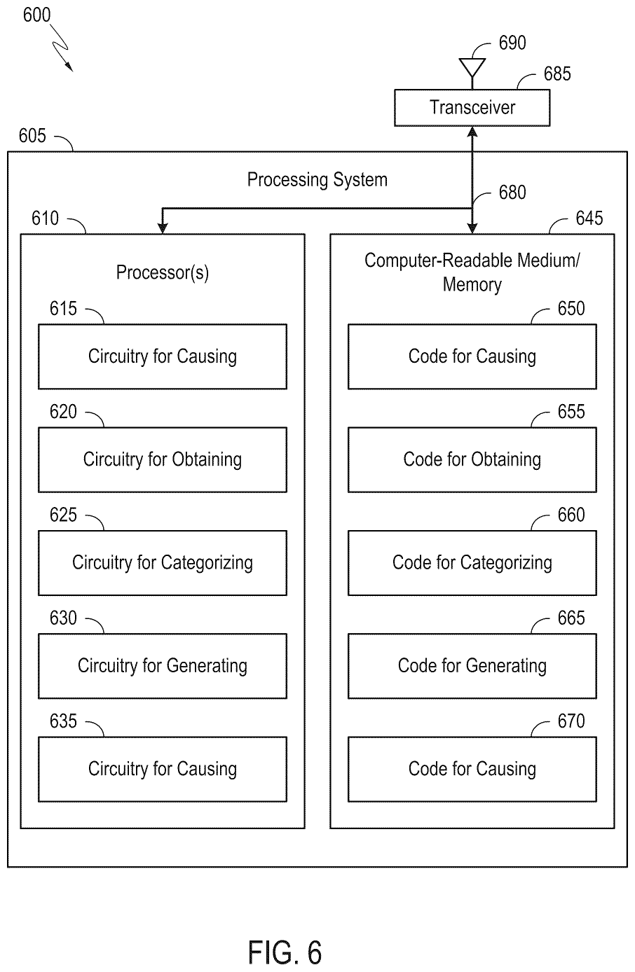

FIG. 5 depicts a flowchart of a method 500 for personalizing interactions and communications with a user through an artificial intelligence based system as described herein. In certain embodiments, the method 500 may be implemented by an apparatus 600, for example, depicted and described with reference to FIG. 6 or another computing device such as the electronic control unit 130 comprising one or more processors 132 and a non-transitory computer readable memory 134 depicted and described with reference to FIG. 1.

Method 500 begins at block 505 with causing one or more user interface devices to implement a first interaction with a user. For example, block 505 may include using the one or more interface devices 440 of FIG. 4 and/or the vehicle display 149, the speaker 144, and/or other input devices for interacting with the user.

Method 500 then proceeds to block 510 with obtaining, from one or more sensors, user centric information corresponding to the user and the first interaction. For example, the one or more sensors may include one or more of the sensors described with reference to FIG. 1 and or other input or sensing devices configured to obtain user centric information 405 and the first interaction.

Method 500 then proceeds to block 515 with categorizing the user centric information into one or more categories corresponding to one or more human responses conveyed in the user centric information. For example, the categorizing the user centric information may be carried out using one or more machine learning models 410, for example, a multi-modal visual-acoustic processing generative transformer based decoder or other model(s).

Method 500 then proceeds to block 520 with generating a second interaction with a generative artificial intelligence (AI) based on a prompt comprising instructions to minimize negative human responses in the user centric information by changing one or more characteristics of the first interaction, and the user centric information categorized into the one or more categories. For example, a prompt 402 as described herein with reference to at least FIG. 4 and a generative AI model 415 as described herein with reference to at least FIG. 4 may enable block 520.

Method 500 then proceeds to block 525 with causing the one or more user interface devices to implement the second interaction with the user. For example, block 525 may include using the one or more interface devices 440 of FIG. 4 and/or the vehicle display 149, the speaker 144, and/or other input devices for interacting with the user.

In some aspects, the first interaction and the second interaction are implemented by a virtual companion model through the one or more user interface devices.

In some aspects, the user centric information comprises at least one of: audio data corresponding to an utterance of the user, image data corresponding to a facial feature of the user, or physiological data corresponding to the user.

In some aspects, the one or more categories comprise an indication that the one or more human responses is a positive response or a negative response.

In some aspects, the one or more human responses comprises at least one of: one or more behaviors indicating stress, one or more behaviors indicating anxiety, one or more behaviors indicating confusion, one or more behaviors indicating contentment, or one or more behaviors indicating irritation.

In some aspects, the one or more characteristics comprise at least one of: a tone of voice, a layout or design of content presented, an audio or visual intensity, or an amount of information conveyed in the first interaction.

In some aspects the method 500 further includes executing one or more additional iterations comprising the steps to: cause the one or more user interface devices to implement an additional interaction with a user, wherein in at least one of the one or more additional iterations the additional interaction is the second interaction; obtain, from the one or more sensors, the user centric information corresponding to the user and the additional interaction; categorize the user centric information into the one or more categories corresponding to the one or more human responses conveyed in the user centric information; generate another additional interaction with the generative artificial intelligence (AI) based on the prompt comprising instructions to minimize negative human responses in the user centric information by changing the one or more characteristics of the additional interaction, and the user centric information categorized into the one or more categories; and cause the one or more user interface devices to implement the another additional interaction with the user.

In some aspects, method 500, or any aspect related to it, may be performed by an apparatus, such as apparatus 600 of FIG. 6, which includes various components operable, configured, or adapted to perform the method 500. Apparatus 600 is described below in further detail.

Note that FIG. 5 is just one example of a method, and other methods including fewer, additional, or alternative operations are possible consistent with this disclosure.

The functional blocks and/or flowchart elements described herein may be translated onto machine-readable instructions. As non-limiting examples, the machine-readable instructions may be written using any programming protocol, such as: (i) descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

FIG. 6 depicts an example apparatus 600 configured to perform the methods described herein. FIG. 6 depicts aspects of an example apparatus 600 configured for interaction techniques as described herein. In some aspects, apparatus 600 is may be the electronic control unit 130 comprising one or more processors 132 and a non-transitory computer readable memory 134 shown for example in FIG. 1. In certain aspects, the apparatus 600 may be a vehicle or other device as discussed herein.

The apparatus 600 includes a processing system 605 coupled to a transceiver 685 (e.g., a transmitter and/or a receiver). The transceiver 685 is configured to transmit and receive signals for the apparatus 600 via an antenna 690, such as the various signals as described herein. The processing system 605 may be configured to perform processing functions for the apparatus 600, including processing signals received and/or to be transmitted by the apparatus 600.

The processing system 605 includes one or more processors 610 and a computer-readable medium/memory 645. In various aspects, the one or more processors 610 may be representative of the one or more processors of a computing device. The one or more processors 610 are coupled to a computer-readable medium/memory 645 via a bus 680. In some aspects, the computer-readable medium/memory 645 may be representative of the one or more memories (e.g., the non-transitory computer readable memory 134 described with respect to FIG. 1). The computer-readable medium/memory 645 may be a non-transitory computer-readable medium/memory. In certain aspects, the computer-readable medium/memory 645 may be configured to store instructions (e.g., computer-executable code), that when executed by the one or more processors 610, cause the one or more processors 610 to perform the method 500 described with respect to FIG. 5, or any aspect related to it, including any operations described in relation to FIG. 5. Note that reference to a processor performing a function of apparatus 600 may include one or more processors performing that function of apparatus 600, such as in a distributed fashion.

In the depicted example, computer-readable medium/memory 645 stores code (e.g., executable instructions), including code for causing 650, code for obtaining 655, code for categorizing 660, code for generating 665, and code for causing 670. Processing of the code 650-670 may enable and cause the apparatus 600 to perform the method 500 described with respect to FIG. 5, or any aspect related to it.

The one or more processors 610 include circuitry configured to implement (e.g., execute) the code stored in the computer-readable medium/memory 645, including circuitry for causing 615, circuitry for obtaining 620, circuitry for categorizing 625, circuitry for generating 630, and circuitry for causing 635. Processing with circuitry 615-635 may enable and cause the apparatus 600 to perform the method 500 described with respect to FIG. 5, or any aspect related to it.

More generally, means for communicating, transmitting, sending or outputting for transmission may include the one or more transceivers 685, one or more antennas 690 of the apparatus 600 in FIG. 6, and/or one or more processors 610 of the apparatus 600 in FIG. 6. Means for communicating, receiving or obtaining may include the one or more transceivers 685, one or more antennas 690 of the apparatus 600 in FIG. 6, and/or one or more processors 610 of the apparatus 600 in FIG. 6.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured for personalizing interaction with a user, comprising: one or more memories; and one or more processors coupled to the one or more memories and configured to cause the apparatus to:
cause one or more user interface devices to implement a first interaction with a user;
obtain, from one or more sensors, user centric information corresponding to the user and the first interaction;
categorize the user centric information into one or more categories corresponding to one or more human responses conveyed in the user centric information;
in response to the user centric information being categorized into one of the one or more categories corresponding to a negative human response, generate a second interaction with a generative artificial intelligence (AI) based on a prompt comprising instructions to minimize negative human responses in the user centric information by changing one or more characteristics of the first interaction, and the user centric information categorized into the one or more categories; and
cause the one or more user interface devices to implement the second interaction with the user.

2. The apparatus of claim 1, wherein the first interaction and the second interaction are implemented by a virtual companion model through the one or more user interface devices.

3. The apparatus of claim 1, wherein the user centric information comprises at least one of:
audio data corresponding to an utterance of the user,
image data corresponding to a facial feature of the user, or
physiological data corresponding to the user.

4. The apparatus of claim 1, wherein the one or more categories comprise an indication that the one or more human responses is a positive response or a negative response.

5. The apparatus of claim 1, wherein the one or more human responses comprises at least one of:
one or more behaviors indicating stress,
one or more behaviors indicating anxiety,
one or more behaviors indicating confusion,
one or more behaviors indicating contentment, or
one or more behaviors indicating irritation.

6. The apparatus of claim 1, wherein the one or more characteristics comprise at least one of:
a tone of voice,
a layout or design of content presented,
an audio or visual intensity, or
an amount of information conveyed in the first interaction.

7. The apparatus of claim 1, wherein the apparatus if further configured to execute one or more additional iterations comprising the steps to:
cause the one or more user interface devices to implement an additional interaction with a user, wherein in at least one of the one or more additional iterations the additional interaction is the second interaction;
obtain, from the one or more sensors, the user centric information corresponding to the user and the additional interaction;
categorize the user centric information into the one or more categories corresponding to the one or more human responses conveyed in the user centric information;
generate another additional interaction with the generative artificial intelligence (AI) based on the prompt comprising instructions to minimize negative human responses in the user centric information by changing the one or more characteristics of the additional interaction, and the user centric information categorized into the one or more categories; and
cause the one or more user interface devices to implement the another additional interaction with the user.

8. A method for interaction, comprising:
causing one or more user interface devices to implement a first interaction with a user;
obtaining, from one or more sensors, user centric information corresponding to the user and the first interaction;
categorizing the user centric information into one or more categories corresponding to one or more human responses conveyed in the user centric information;
in response to categorizing the user centric information into one of the one or more categories corresponding to a negative human response, generating a second interaction with a generative artificial intelligence (AI) based on a prompt comprising instructions to minimize negative human responses in the user centric information by changing one or more characteristics of the first interaction, and the user centric information categorized into the one or more categories; and
causing the one or more user interface devices to implement the second interaction with the user.

9. The method of claim 8, wherein the first interaction and the second interaction are implemented by a virtual companion model through the one or more user interface devices.

10. The method of claim 8, wherein the user centric information comprises at least one of:
audio data corresponding to an utterance of the user,
image data corresponding to a facial feature of the user, or
physiological data corresponding to the user.

11. The method of claim 8, wherein the one or more categories comprise an indication that the one or more human responses is a positive response or a negative response.

12. The method of claim 8, wherein the one or more human responses comprises at least one of:
one or more behaviors indicating stress,
one or more behaviors indicating anxiety,
one or more behaviors indicating confusion,
one or more behaviors indicating contentment, or
one or more behaviors indicating irritation.

13. The method of claim 8, wherein the one or more characteristics comprise at least one of:
a tone of voice,
a layout or design of content presented,
an audio or visual intensity, or
an amount of information conveyed in the first interaction.

14. The method of claim 8, further comprising executing one or more additional iterations comprising:
causing the one or more user interface devices to implement an additional interaction with a user, wherein in at least one of the one or more additional iterations the additional interaction is the second interaction;
obtaining, from the one or more sensors, the user centric information corresponding to the user and the additional interaction;
categorizing the user centric information into the one or more categories corresponding to the one or more human responses conveyed in the user centric information;
generating another additional interaction with the generative artificial intelligence (AI) based on the prompt comprising instructions to minimize negative human responses in the user centric information by changing the one or more characteristics of the additional interaction, and the user centric information categorized into the one or more categories; and
causing the one or more user interface devices to implement the another additional interaction with the user.

15. A non-transitory computer-readable medium comprising processor-executable instructions that, when executed by one or more processors of an apparatus, causes the apparatus to perform a method comprising:
causing one or more user interface devices to implement a first interaction with a user;
obtaining, from one or more sensors, user centric information corresponding to the user and the first interaction;
categorizing the user centric information into one or more categories corresponding to one or more human responses conveyed in the user centric information;
in response to categorizing the user centric information into one of the one or more categories corresponding to a negative human response, generating a second interaction with a generative artificial intelligence (AI) based on a prompt comprising instructions to minimize negative human responses in the user centric information by changing one or more characteristics of the first interaction, and the user centric information categorized into the one or more categories; and
causing the one or more user interface devices to implement the second interaction with the user.

16. The non-transitory computer-readable medium of claim 15, wherein the first interaction and the second interaction are implemented by a virtual companion model through the one or more user interface devices.

17. The non-transitory computer-readable medium of claim 15, wherein the user centric information comprises at least one of:
audio data corresponding to an utterance of the user,
image data corresponding to a facial feature of the user, or
physiological data corresponding to the user.

18. The non-transitory computer-readable medium of claim 15, wherein the one or more categories comprise an indication that the one or more human responses is a positive response or a negative response.

19. The non-transitory computer-readable medium of claim 15, wherein the one or more human responses comprises at least one of:
one or more behaviors indicating stress,
one or more behaviors indicating anxiety,
one or more behaviors indicating confusion,
one or more behaviors indicating contentment, or
one or more behaviors indicating irritation.

20. The non-transitory computer-readable medium of claim 15, wherein the processor-executable instructions that, when executed by the one or more processors of the apparatus, further cause the apparatus to execute one or more additional iterations comprising:
causing the one or more user interface devices to implement an additional interaction with a user, wherein in at least one of the one or more additional iterations the additional interaction is the second interaction;
obtaining, from the one or more sensors, the user centric information corresponding to the user and the additional interaction;
categorizing the user centric information into the one or more categories corresponding to the one or more human responses conveyed in the user centric information;
generating another additional interaction with the generative artificial intelligence (AI) based on the prompt comprising instructions to minimize negative human responses in the user centric information by changing the one or more characteristics of the additional interaction, and the user centric information categorized into the one or more categories; and
causing the one or more user interface devices to implement the another additional interaction with the user.
